(19) United States
(12) Patent Application Publication
(10) Pub. No.: US 2020/0310727 A1
(43) Pub. Date: Oct. 1, 2020

(54) METHOD AND SYSTEM FOR PROVIDING MEETING ATTENDEES PREFERRED PRINT SETTINGS USING RESPONSES RECEIVED BY THE PRESENTER

(71) Applicant: Konica Minolta Laboratory U.S.A., Inc., San Mateo, CA (US)

(72) Inventor: Amitha Hebbar, Foster City, CA (US)

(73) Assignee: Konica Minolta Laboratory U.S.A., Inc., San Mateo, CA (US)

(21) Appl. No.: 16/369,122

(22) Filed: Mar. 29, 2019

(51) Int. Cl. G06F 3/12; H04N 1/32; H04N 1/00

(52) U.S. Cl. CPC G06F 3/1271; G06F 3/1204; G06F 3/1257; H04N 1/00954; G06F 3/1288; H04N 1/32085; G06F 3/1272

(57) ABSTRACT

A printing method, a non-transitory computer readable medium, and a system are disclosed for providing meeting attendees with printed materials. The printing method including receiving a result of an invitation to one or more users; transferring an identifier to an image forming apparatus for the one or more users having accepted the invitation; transferring a material to be printed to the image forming apparatus; printing the material based on a print preference setting when the image forming apparatus has the print preference setting for the one or more users; and printing the material based on an original print setting of the material when the image forming apparatus does not have the print preference setting for the one or more users.

### FIELD OF THE INVENTION

The present disclosure generally relates to a method and system for providing meeting attendees preferred print setting using responses received by the presenter, for example, via a response to an invitation email.

### BACKGROUND OF THE INVENTION

When a group of people attending a conference and/or meeting, everyone has their preferred print results for printed materials, for example, in consideration of color blindness adjustments, font size adjustments, duplex or simplex printing choices and so on. If an attendee has a copy of the materials prior to the conference and/or meeting, the attendee can print a copy of the materials with the attendee's preferred print results and/or favorite settings.

However, when conference material is distributed to the attendees by the presenter, attendees, for example, may ask for reprinting of the printed material before, during and/or after the conference, if the printed materials do not match their preferred setting.

### SUMMARY OF THE INVENTION

In consideration of the above, it would be desirable to have a method and system for printing each attendees preferred choice of print results based on the received response of each of the attendees. In addition, the method and system provides that the presenter print only the material for the actual meeting attendees, rather than printing for a large generic group, which may or may not attend the presentation or meeting. In addition, the method and system can manually track attendees by printing identifiers (IDs) on the printed material, which can be used to determine if an attendee actually was present during the meeting or presentation.

A printing method is disclosed comprising: receiving a result of an invitation to one or more users; transferring an identifier to an image forming apparatus for the one or more users having accepted the invitation; transferring a material to be printed to the image forming apparatus; printing the material based on a print preference setting when the image forming apparatus has the print preference setting for the one or more users; and printing the material based on an original print setting of the material when the image forming apparatus does not have the print preference setting for the one or more users.

A non-transitory computer readable medium (CRM) storing computer program code executed by a computer processor that performs a printing method is disclosed, the method comprising: receiving a result of an invitation to one or more users; transferring an identifier to an image forming apparatus for the one or more users having accepted the invitation; transferring a material to be printed to the image forming apparatus; printing the material based on a print preference setting when the image forming apparatus has the print preference setting for the one or more users; and printing the material based on an original print setting of the material when the image forming apparatus does not have the print preference setting for the one or more users.

A printing system is disclosed, the system comprising: one or more client devices configured to: receive a result of an invitation to one or more users; transfer an identifier to an image forming apparatus for the one or more users having accepted the invitation; and transfer a material to be printed to the image forming apparatus; and the image forming apparatus configured to: print the material based on a print preference setting when the image forming apparatus has the print preference setting for the one or more users; and print the material based on an original print setting of the material when the image forming apparatus does not have the print preference setting for the one or more users.

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a system for providing meeting attendees preferred print settings using responses received by a presenter in accordance with an exemplary embodiment.

FIG. 2 is an illustration of a client device or computer device in accordance with an exemplary embodiment.

FIG. 3 is an illustration of an image forming apparatus in the form of printer, printing device, or multi-function printer (MFP) in accordance with an exemplary embodiment.

FIG. 4 is an illustration of print settings for one or more individual in accordance with an exemplary embodiment.

FIG. 5 is an illustration of a graphical user interface (GUI) with preference registration in accordance with an exemplary embodiment.

FIG. 6 is flow chart illustrating preferred print settings for attendees in accordance with an exemplary embodiment.

FIG. 7 is an illustration of a plurality of preferred print settings in accordance with an exemplary embodiment.

FIG. 8 is an illustration of a graphical user interface (GUI) for generating a print email with preferred print settings in accordance with an exemplary embodiment.

FIG. 9 is another illustration of a graphical user interface (GUI) for generating a print email with preferred print settings in accordance with an exemplary embodiment.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

In accordance with an exemplary embodiment, a method and system is disclosed, which provides a solution to printing meeting material for the attendees based on print preferences of the attendees (for example, font style, font size, color blindness adjustment, etc.), and wherein the materials are printed prior to the presentation by the presenter (or individual or organizer hosting the meeting or presentation) based on responses received from the attendees, for example, to a meeting invite. For example, the printing of the material based on the users' print preference setting can include E-print, that is, sending electronic data of the meeting material to a user, which has selected E-print as their print preference setting. In accordance with an exemplary embodiment, the meeting invite (or invitation) is an invitation email.

In accordance with an exemplary embodiment, each attendee's (for example, an employee's) preferred print setting can be stored in a multi-function printer (MFP), printer, or server. When the presenter sends the print job to the MFP with a list of meeting attendees, the printer or MFP will automatically retrieve the attendee's print preference settings and the corresponding print settings will be applied to the print output for each of the attendees at the meeting.

In accordance with an exemplary embodiment, the presenter of the meeting can print each attendee's (or individual's) preferred print results based on their acceptance for the meeting invitation. In addition, by storing each attendee's or individual's print preferences on the MFP or a server, the presenter or administrator is not required to manually enter the attendee's or individual's personal identifier (ID) nor manually count the number of attendees, which plan to attend the meeting, before printing the material(s) for the meeting. For example, in accordance with an exemplary embodiment, the method and system as disclosed can print the material for the meeting upon each of the attendee's acceptance, or alternatively, the materials can be printed in a single print job at the request of the presenter (or organizer of the event). In accordance with the method and system as disclosed, extra print copies of meetings materials can be avoided since the only copies that are printed are for the attendees, rather than for each invitee or an entire group or division, for example, of a company, without regard to an actual number of employees attending the meeting.

In accordance with an exemplary embodiment, the method and system as disclosed provide the presenter of the meeting with a method or process for using the meeting invitee's responses and printing the material of attendees in accordance with the attendees' preferred print settings. For example, each employee's preferred print setting can be stored in the image forming apparatus, for example, a printer or a MFP, or alternatively, in a separate server. When the presenter sends the print job to MFP with these meeting attendees, the image forming apparatus, for example, the printer or MFP will automatically retrieve the attendee's preferences and the corresponding print settings will be applied to the print output for the presenter and the meeting attendees.

In accordance with an exemplary embodiment, if the system administrator has set policies for the materials to be printed by the presenter, for example, requirements that the materials be printed use of duplex or monochrome printing, if the print policies conflicts with the attendees preferences, the polices set by the administrator can be implemented. For example, the material will not be printed in color. In accordance with an exemplary embodiment, alternatively, the attendee's preferences can take precedence over a presenter's individual policy set by the administrator, and the material can be printed per the attendee's preferred print settings.

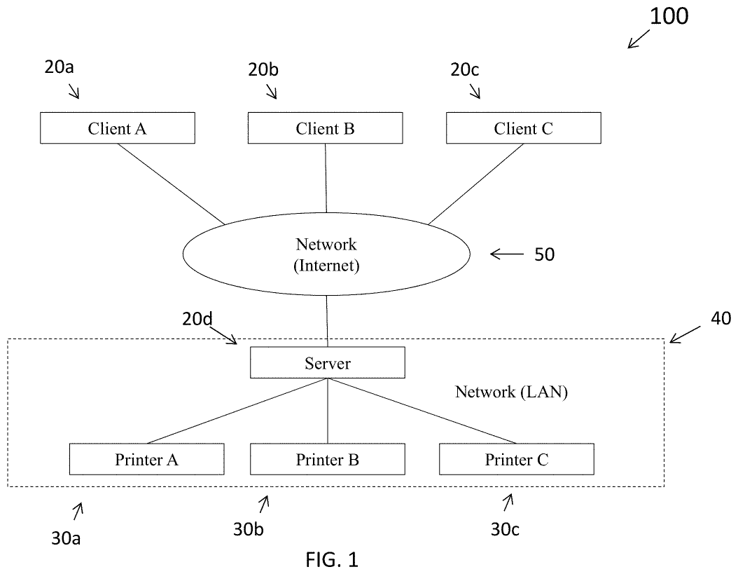

FIG. 1 is an illustration of a system 100 for providing meeting attendees preferred print settings using responses received by a presenter in accordance with an exemplary embodiment. As shown in FIG. 1, the system 100 includes one or more client devices or servers 20a, 20b, 20c, 20d, one or more printers 30a, 30b, 30c, and a communication network 50. The communication network or network 50 can be a public telecommunication line and/or a network (for example, LAN or WAN). Examples of the communication network 50 can include any telecommunication line and/or network consistent with embodiments of the disclosure including, but are not limited to, telecommunication or telephone lines, the Internet, an intranet, a local area network (LAN) as shown, a wide area network (WAN) and/or a wireless connection using radio frequency (RF) and/or infrared (IR) transmission.

In accordance with an exemplary embodiment, each of the one or more client devices 20a, 20b, 20c, 20d can be, for example, a personal computer (PC), a laptop, a mobile computing device (e.g., tablet PC, smartphone, etc.), a server, a mainframe, or a kiosk. As shown in FIG. 1, one or more of the client devices, for example, server 20d, and each of the one or more printers 30a, 30b, 30c 0b, can be connected to each other with a network, for example, a local area network (LAN) 40. In addition, each of the one or more client devices or servers 20a, 20b, 20c, 20d, and the one or more printers 30a, 30b, 30c, can be connected by one or more communication networks 50 of any size having wired and/or wireless segments. Each of the one or more client devices 20a, 20b, 20c, can be operated by a different user

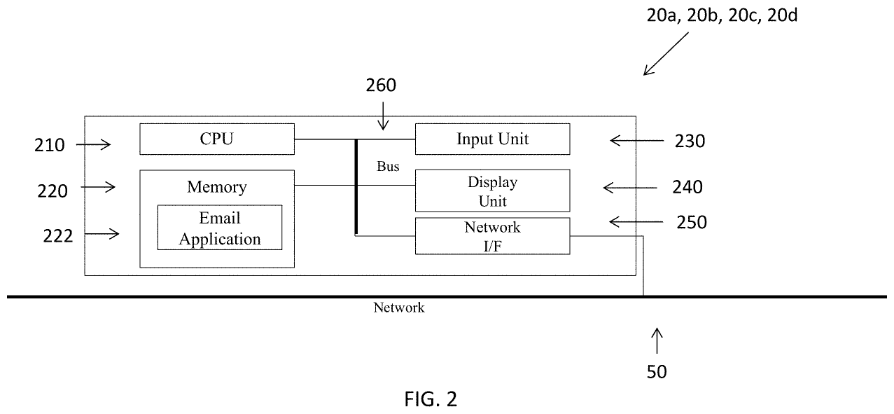

FIG. 2 is an illustration of client device or client computer 20a, 20b, 20c, 20d in accordance with an exemplary embodiment. As shown in FIG. 2, each of the one or more client devices or client computers 20a, 20b, 20c, 20d can include a processor or central processing unit (CPU) 210, and one or more memories 220 for storing software programs and data, which can include an email application (or client application) 222. The processor or CPU 220 is configured to carry out the instructions of a computer program, which operates and/or controls at least a portion of the functionality of the client device or client computer 20a, 20b, 20c, 20d. The client device or client computer 20a, 20b, 20c, 20d can also include an input unit 230, a display unit or graphical user interface (GUI) 240, and a network interface (I/F) 250, which is connected to a communication network (or network) 50. A bus 260 can connect the various components 210, 220, 230, 240, and 250 within client device or client computer 20a, 20b, 20c, 20d. The client device or client computer 20a, 20b, 20c, 20d includes an operating system (OS), which manages the computer hardware and provides common services for efficient execution of various software programs as disclosed herein.

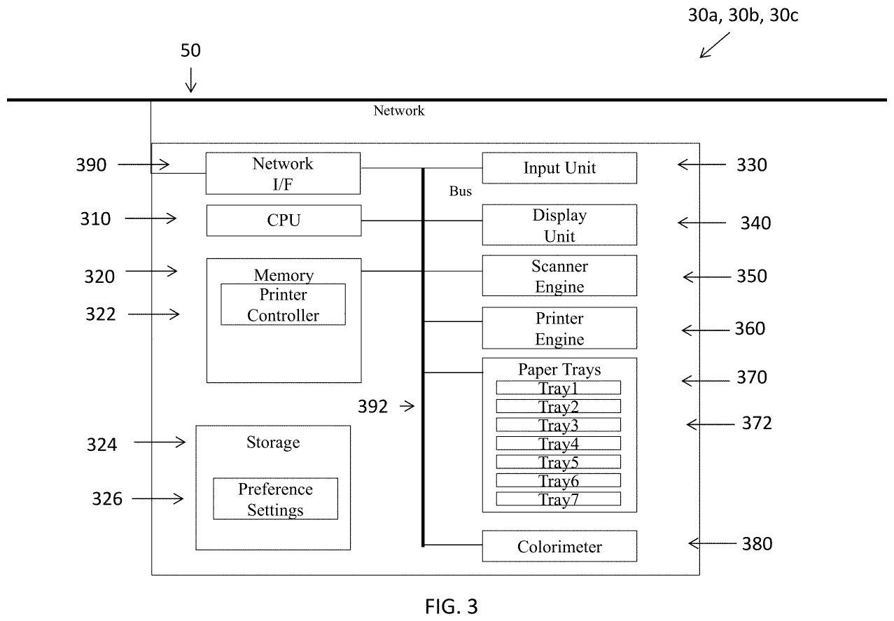

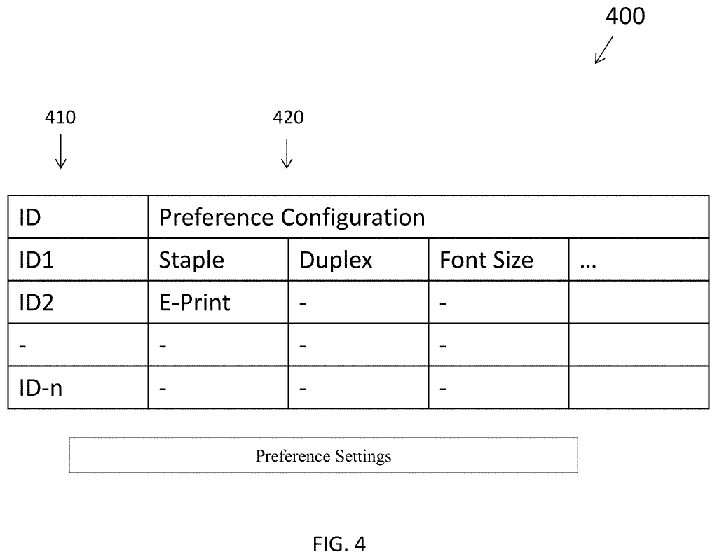

FIG. 3 is an illustration of an image forming apparatus in the form of printer, printing device, or multi-function printer (MFP) 30a, 30b, 30c, in accordance with an exemplary embodiment. As shown in FIG. 4, the printer or printing device 30a, 30b, 30c can include a network interface (I/F) 390, which is connected to the communication network (or network) 50, a processor or central processing unit (CPU) 310, and one or more memories 320 for storing software programs and data (such as files to be printed) 322. For example, the software programs 322 can include a printer controller and a tray table. The processor or CPU 310 carries out the instructions of a computer program, which operates and/or controls at least a portion of the functionality of the printer 30a, 30b, 30c. The printer 30a, 30b, 30c can also include an input unit 330, a display unit or graphical user interface (GUI) 340, a scanner engine (or scanner) 350, a printer engine 360, a plurality of paper trays 370, for example, tray 1, tray 2 . . . 372, and a colorimeter 380.

In accordance with an exemplary embodiment, the colorimeter 380 can be an inline colorimeter (ICCU) (or spectrophotometer), which measures printed color patches in order to generate color profiles. In accordance with an exemplary embodiment, for example, the colorimeter (or spectrophotometer) 380 can be one or more color sensors or colorimeters, such as an RGB scanner, a spectral scanner with a photo detector or other such sensing device known in the art, which can be embedded in the printed paper path, and an optional finishing apparatus or device (not shown). A bus 392 can connect the various components 310, 320, 330, 340, 350, 360, 370, 380, and 390 within the printer 30a, 30b, 30c. The printer 30a, 30b, 30c also includes an operating system (OS), which manages the computer hardware and provides common services for efficient execution of various software programs. In accordance with an exemplary embodiment, it can be within the scope of the disclosure for the printer 30a, 30b, 30c to be a copier.

For example, in accordance with an exemplary embodiment, an image processing section within the printer 30a, 30b, 30c can carry out various image processing under the control of a print controller or CPU 310, and sends the processed print image data to the print engine 360. The image processing section can also include a scanner section (scanner engine 350) for optically reading a document, such as an image recognition system. The scanner section receives the image from the scanner engine 350 and converts the image into a digital image. The print engine 360 forms an image on a print media (or recording sheet) based on the image data sent from the image processing section. The central processing unit (CPU) (or processor) 310 and the memory 320 can include a program for RIP processing (Raster Image Processing), which is a process for converting print data included in a print job into Raster Image data to be used in the printer or print engine 360. The CPU 310 can include a printer controller configured to process the data and job information received from the one or more client device or client computer 20a, 20b, 20c, 20d, for example, received via the network connection unit and/or input/output section (I/O section) 390.

The CPU 310 can also include an operating system (OS), which acts as an intermediary between the software programs and hardware components within the multi-function peripheral. The operating system (OS) manages the computer hardware and provides common services for efficient execution of various software applications. In accordance with an exemplary embodiment, the printer controller can process the data and job information received from the one or more client device or client computer 20a, 20b, 20c, 20d to generate a print image.

In accordance with an exemplary embodiment, the network I/F 390 performs data transfer with the client device or client computer 20a, 20b, 20c, 20d. The printer controller can be programmed to process data and control various other components of the multi-function peripheral to carry out the various methods described herein. In accordance with an exemplary embodiment, the operation of printer section commences when the printer section receives a page description from the one or more client device or client computer 20a, 20b, 20c, 20d via the network I/F 390 in the form of a print job data stream and/or fax data stream. The page description may be any kind of page description languages (PDLs), such as PostScript® (PS), Printer Control Language (PCL), Portable Document Format (PDF), and/or XML Paper Specification (XPS). Examples of printers 30a, 30b, 30c consistent with exemplary embodiments of the disclosure include, but are not limited to, a multi-function peripheral (MFP), a laser beam printer (LBP), an LED printer, a multi-function laser beam printer including copy function.

In accordance with an exemplary embodiment, the printer 30a, 30b, 30c can also include at least one auto tray or paper tray 370, and more preferably a plurality of auto trays or paper trays 372. Each auto tray or paper tray 372 can include a bin or tray, which holds a stack of a print media (not shown), for example, a paper or a paper-like product. The printer engine or print engine 360 has access to a print media of various sizes and workflow for a print job, which can be, for example, stored in the input tray. A “print job” or “document” can be a set of related sheets or printed materials, usually one or more collated copy sets copied from a set of original print job sheets or electronic document page images, from a particular user, or otherwise related.

In accordance with an exemplary embodiment, the print media is preferably a paper or paper-like media having one or more print media attributes. The print media attributes can include, for example, paper color, coating, grain direction, printing technology, brightness, CIE, tint, whiteness, labColor, etc. In order to maximize print quality, the print media attributes of each type of print media should be input into or hosted on the printer 30a, 30b, 30c, for example, on printer configuration settings of the printer 30a, 30b, 30c, to obtain the highest quality output. Most print media is provided in reams or other known quantities, which are packaged with indicia such as information on the manufacture, size, type and other attributes of the print media. In addition, most bundles or reams of paper include a UPC (Universal Product Code) or bar code, which identifies the type of print media including manufacture of the print media.

FIG. 4 is an illustration of print settings 400 for one or more individual in accordance with an exemplary embodiment. As shown in FIG. 4, the print settings (i.e., print preferences) of a plurality of individuals, for example, employees, conference attendees, suppliers, or anyone that may attend a meeting can be saved in a database (or memory) of the printer 30a, 30b, 30c, or server 20d. Each of the plurality of individuals can have an identifier (or ID) 410 assigned to them and corresponding print preferences 420, for example, finishing (e.g., staple, folding, binding, die-stamping, embossing, laminating), duplex, font size, e-print or e-copy, etc. In accordance with an exemplary embodiment, e-print or e-copy can be digital version of the material preferably in the user's print preference setting.

In accordance with an exemplary embodiment, the identifier (or ID) can be assigned to a group of users or a plurality of users. For example, ID1 can be assigned to executives, ID2 could be assigned to managers, and ID-n to staff. Thus, rather than individual users, in accordance with an exemplary embodiment, the print preference settings can be assigned by an administrator to one or more groups ID1, ID2, . . . 410.

In accordance with an exemplary embodiment, the print preferences for each individual (or attendee) can include one or more preference settings, for example, each individual (or attendee) can have a setting for different types of documents, i.e., based on the number of pages, type of document, for example, multi-page handout, brochure, pamphlet, etc., or alternatively, the individual's (or attendee's) preference settings can be for all types of print job or materials presented at meetings. In addition, the preference settings for each of the individuals or attendees can be based on the type of meeting, for example, board meeting having a limited number of attendees, or a general meeting, for example, open to an entire company.

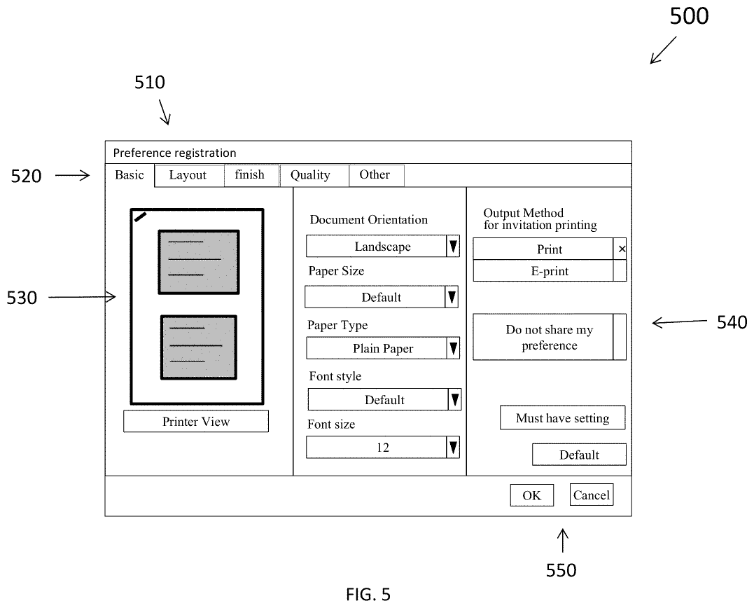

FIG. 5 is an illustration of a graphical user interface (GUI) 500 with preference registration 510 in accordance with an exemplary embodiment. As shown in FIG. 5, each attendee or individual upon receipt of a meeting invite or prior to receipt of the meeting invite can set her or his preference settings (i.e., preferred print settings). In accordance with an exemplary embodiment, the preference settings 520 can include, for example, a basic setting, a layout setting, a finish setting, a quality setting, and other. For example, in the basic setting the graphical user interface, for example, as presented on the client device 20a, 20b, 20c, of the attendee or individual can include a printer view 530, and a plurality of pull-down windows or check boxes 540 requesting print preferences related to, for example, document orientation (i.e., portrait or landscape), paper size, paper type, font style, font size, output method for invitation printing, for example, print or e-print, a share or do not share preference option, and an optional “must have setting”. In accordance with an exemplary embodiment, the user can select “do not share my preference” and opt out of providing any print preferences. In the “do not share my preference”, the user will receive a regular copy (i.e., original print settings) for any invitation that the user has responded to in the positive, i.e., the user will attend the meeting or presentation.

In accordance with an exemplary embodiment, the “must have setting” can be a preference of the attendee or individual user, for example, font size, or a color blindness setting that can override settings set by the presenter in the printing of the materials. Alternatively, for some print jobs, the “must have settings” may not be able to applied to the print job, for example, the printer 30a may not be able to reproduce the requested print setting and the printed materials will not include the “Must have setting” of the user. In accordance with an exemplary embodiment, the print job can be sent to another printer 30b, 30c, which can print the material with the “must have settings”.

In addition, the preference registration 510 can include a default setting, which set the attendee's or individual's preference to a default setting, an “OK” button to approve of the settings, and a “cancel” button, if the user wishes to reset the options and input new or different print preferences.

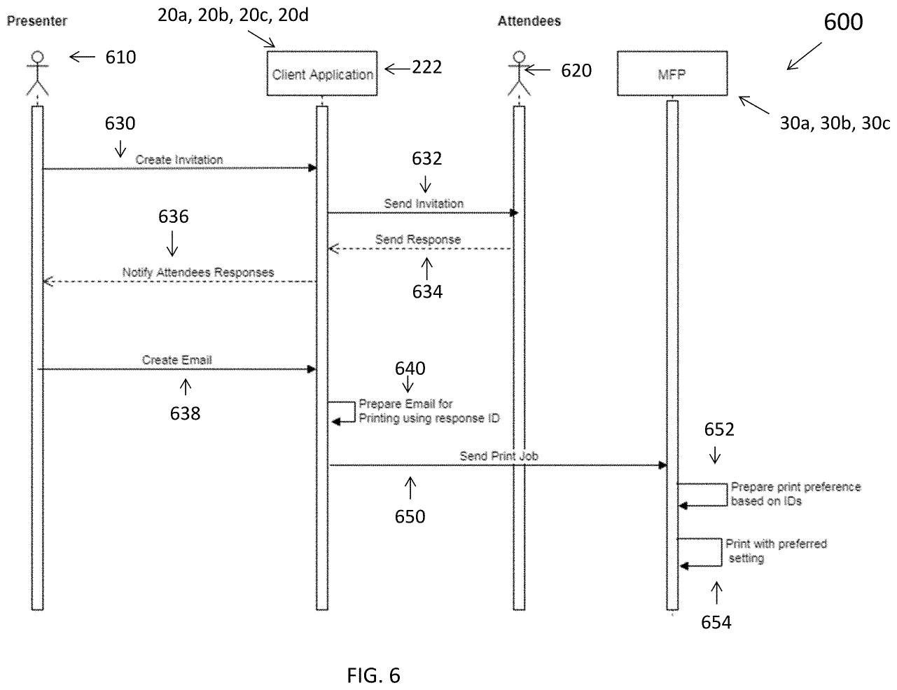

FIG. 6 is flow chart 600 illustrating preferred print settings for attendees in accordance with an exemplary embodiment. As shown in FIG. 6, for any meeting or presentation, generally, the meeting or presentation will include a presenter 610 having access to an email application (or client application) 222, which is preferably hosted on a client device or server, 20a, 20b, 20c, 20d, one or more attendees 620, and a printer (or MFP) 30a, 30b, 30c. In step 630, the presenter 610 creates an invitation email for a meeting. In accordance with an exemplary embodiment, rather than an invitation email, the invite can be via any known invitation system in which an attendee's acceptance can be recorded. For example, the invitation system can be an online invitation that records each attendee's acceptance with a corresponding identifier (i.e., ID). The meeting or presentation, preferably, for example, has a date and time, a meeting location or presentation location, and one or more attendees 620, which have been invited to attend the meeting in person or via a conference call, a video conference call, or video conference chat. In step 632, the client application 222 sends the invitational email to each of the invites requesting a response from the invitee on his or her attendance at the scheduled meeting. In step 634, each of the one or more attendees sends a response to the client application 222, which receives and records the response for each of the one or more attendees. In step 636, the presenter 636 receives a communication from the client application with a list of attendees or a number of attendees scheduled to attend the meeting or presentation.

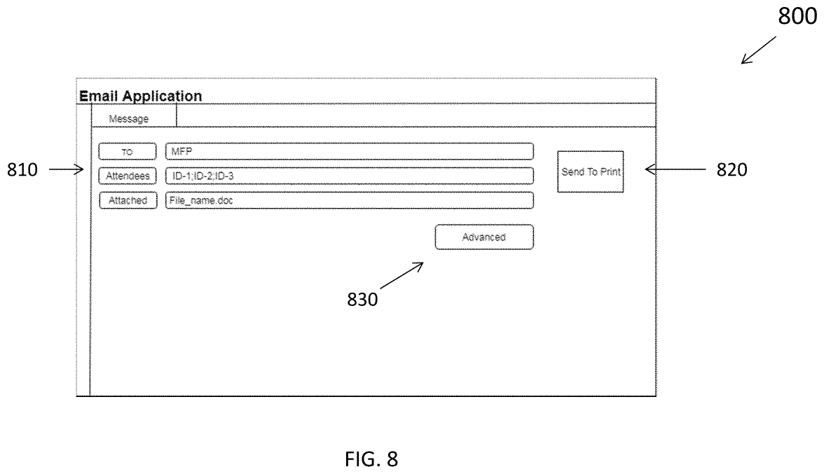

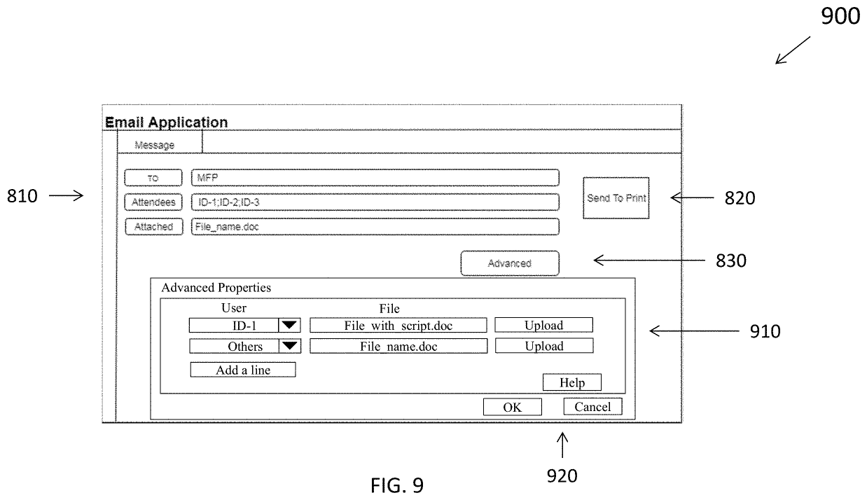

In step 638, the presenter creates a print email, for example, as shown in FIGS. 8 and 9, which the client application 222 forwards to the printer or MFP 30a, 30b, 30c, for printing of the materials for the meeting or presentation. In step 640, the client application 222 prepares the print email for printing of the materials based on those individuals or attendees who responded in the positive, for example, that he or she would be attending the meeting or presentation as scheduled. In step 650, the client application 222 sends the print job to the printer or MFP 30a, 30b, 30c, for example, via the print e-mail prepared in steps 638, 640. In step 652, the printer or MFP 30a, 30b, 30c prepares the print job for printing based on the print preferences for each of the individuals, for example, based on individual identifiers (IDs). In step 654, the printer or MFP 30a, 30b, 30c, prints the materials for the meeting or presentation in accordance with the print preferences of each of the attendees. In accordance with an exemplary embodiment, for ease of distribution, attendees' ID can be added to the printed output. In addition, if any attendees are not registered with preferred print settings, the printer or MFP 30a, 30b, 30c, can notify the presenter and apply a default setting or original print setting to the print request.

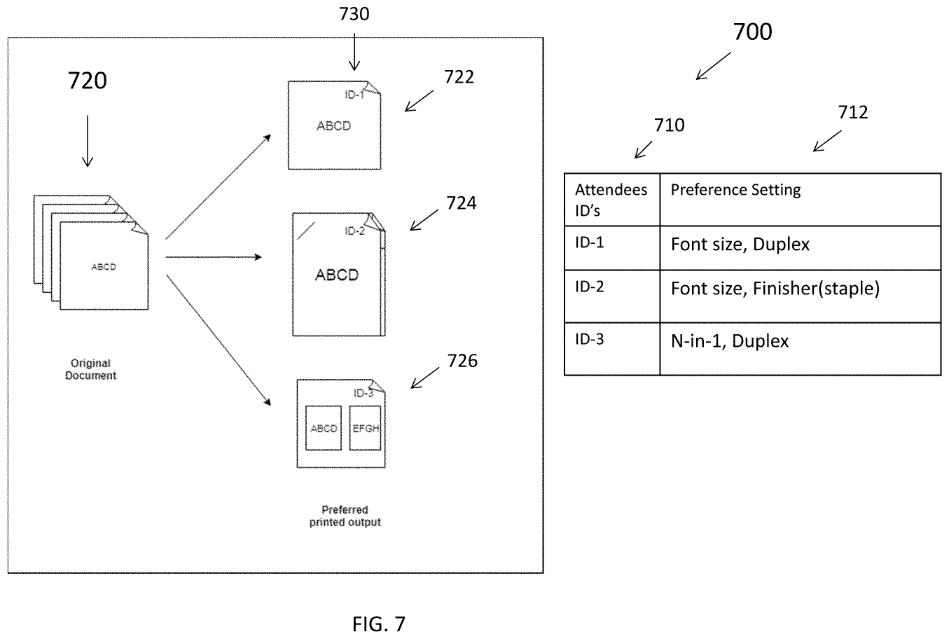

FIG. 7 is an illustration of a plurality of preferred print settings 700 in accordance with an exemplary embodiment. As shown in FIG. 7, in step 652 (FIG. 6), the printer or MFP 30a, 30b, 30c, receives the list of attendees, for example, each of the attendees identifier (ID) 710 and corresponding print preferences 712. In accordance with an exemplary embodiment, the original document or material 720 for a meeting or presentation, can be printed in one or more formats 722, 724, 726 based on the print preferences of each of the attendees. In accordance with an exemplary embodiment, the original document or material 720 is formatted with original print settings, and wherein one or more of the original print settings can be changed or modified. In addition, each of the one or more users is assigned a unique identifier 730, which can be printed on the printed material 722, 724, 726. For example, as shown in FIG. 7, user ID-1 has a print preference 722, which is a same as the original print settings of the material; user ID-2 has a print preference 724 for a font size and a paper size different than the original print settings; and user ID-3 has print preference for two sheets of print material per one page, i.e., 2-in-1 (or number of pages per each sheet, or N-in-1).

FIG. 8 is an illustration of a graphical user interface (GUI) 800 for generating a print email with preferred print settings in accordance with an exemplary embodiment. As shown in FIG. 8, in accordance with an exemplary embodiment, upon receipt of a listing of attendees for a meeting or presentation, the presenter in step 638 prepares a print email to be sent to the printer or MFP 30a, 30b, 30c, with a listing of each of the attendees. In accordance with an exemplary embodiment, the print preferences can be attached to the print email by the client application 222. The print email 640 can be configured to include the file document (i.e., print material), for example, “File_name.doc”, which can be sent to the printer or MFP 30a, 30b, 30c, for printing of the materials for the meeting or presentation. The graphical user interface 800 for generating the print email can also include a “Send to Print” button 820 once each of the attendees has been added to the list of attendees and an optional “Advanced” settings button 830.

FIG. 9 is another illustration of a graphical user interface 900 for generating a print email with preferred print settings in accordance with an exemplary embodiment. As shown in FIG. 9, the optional “Advanced” settings 830 in FIG. 8, can include a plurality of advance properties for each of the one or more attendee (i.e., User), for example, which can include file type, for example, “File_with_script.doc”, or “File_name.doc”. The graphical user interface 900 for generating the print email can also include a “Help” button, an “OK” button, and a “Cancel” button 920.

In accordance with an exemplary embodiment, the methods and processes as disclosed can be implemented on a non-transitory computer readable medium. The non-transitory computer readable medium may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. In view of the foregoing, it is intended that the present invention cover modifications and variations of this invention provided they fall within the scope of the following claims and their equivalents.

1. A printing method comprising:
sending an invitation email to a plurality of users from a client application, the invitation email being an invitation to a conference and/or a meeting;
receiving a result of the invitation to attend the conference and/or the meeting from one or more users of the plurality of users on the client application via a response to the invitation email;
transferring an identifier to an image forming apparatus via a print email for each of the one or more users having accepted the invitation to attend the conference and/or the meeting;
transferring a material to be printed to the image forming apparatus via the print email for each of the one more user having accepted the invitation to attend the conference and/or the meeting, the print email being generated by the client application;
printing the material from the print email on the image forming apparatus based on a print preference setting for each of the one or more users having accepted the invitation to attend the conference and/or the meeting when the image forming apparatus has the print preference setting for a user; and
printing the material from the print email on the image forming apparatus based on an original print setting of the material for each of the one or more users having accepted the invitation to attend the conference and/or the meeting when the image forming apparatus does not have the print preference setting for the user.

2. (canceled)

3. The printing method according to claim 1, comprising:
storing a listing of at least one of the one or more users on the image forming apparatus, the listing of the at least one of the one or more users of the plurality of users including the identifier for each of the at least one of the one or more users and the print preference setting for each of the at least one of the one or more users.

4. The printing method according to claim 1, comprising:
storing a listing of at least one of the one or more users on a server, the listing of the at least one of the one or more users identify the print preference setting for each of the at least one of the one or more users; and
sending the list of the at least one of the one or more users to the image forming apparatus.

5. The printing method according to claim 1, wherein the print preference setting for at least one of the one or more users comprises one or more of the following:
document orientation, paper size, paper type, font style, font size, print or e-print, duplex printing, finishing, and N-in-1.

6. The printing method according to claim 1, comprising:
formatting the material in the original print setting, the original print setting having one or more print settings, which can be changed.

7. The printing method according to claim 1, further comprising:
assigning each of the one or more users a unique identifier; and
printing the unique identifier on the printed material.

8. The printing method according to claim 1, further comprising:
assigning each of the one or more users a regular print preference setting, and wherein the regular print preference setting is a same print setting as the original print setting of the material or a different print setting as the original print setting of the material.

9. The printing method according to claim 1, further comprising:
hosting the identifier for the one or more users on the image forming apparatus.

10. The printing method according to claim 1, further comprising:
sending the print email for the one or more users having accepted the invitation to attend the conference and/or the meeting to a server from the client application;
hosting the identifier of the one or more users on the server;
retrieving the identifier of the one or more users from the server; and
sending the material to the image forming apparatus from the server with the identifier of the one or more users based on the print email received on the server.

11. The printing method according to claim 1, comprising:
providing the one or more users with a graphical user interface with a preference registration screen, the preference registration screen requesting print settings from a user, the print settings including document orientation, paper size, paper type, font style, font size, print or e-print, duplex printing, finishing, and/or N-in-1.

12. (canceled)

13. (canceled)

14. The printing method according to claim 1, comprising:
providing each of the one or more users with an option that the print preference settings are not shared with other users.

15. A non-transitory computer readable medium (CRM) storing computer program code executed by a computer processor that performs a printing method, the method comprising:
sending an invitation email to a plurality of users from a client application, the invitation email being an invitation to a conference and/or a meeting;
receiving a result of the invitation to attend the conference and/or the meeting from one or more users of the plurality of users on the client application via a response to the invitation email;
transferring an identifier to an image forming apparatus via a print email for each of the one or more users having accepted the invitation to attend the conference and/or the meeting;
transferring a material to be printed to the image forming apparatus via the print email for each of the one more user having accepted the invitation to attend the conference and/or the meeting;
printing the material from the print email on the image forming apparatus based on a print preference setting for each of the one or more users having accepted the invitation to attend the conference and/or the meeting when the image forming apparatus has the print preference setting for a user; and
printing the material from the print email on the image forming apparatus based on an original print setting of the material for each of the one or more users having accepted the invitation to attend the conference and/or the meeting when the image forming apparatus does not have the print preference setting for the user.

16. (canceled)

17. The non-transitory computer readable medium according to claim 15, comprising:
storing a listing of at least one of the one or more users on the image forming apparatus, the listing of the at least one of the one or more users of the plurality of users including the identifier for each of the at least one of the one or more users and the print preference setting for each of the at least one of the one or more users.

18. The non-transitory computer readable medium according to claim 15, wherein the print preference setting for the one or more users comprises document orientation, paper size, paper type, font style, font size, print or e-print, duplex printing, finishing, and/or N-in-1, the method further comprising:
storing a listing of at least one of the one or more users on a server, the listing of the at least one of the one or more users identify the print preference setting for each of the at least one of the one or more users; and
sending the list of the at least one of the one or more users to the image forming apparatus; and
formatting the material in the original print setting, the original print setting having one or more print settings, which can be changed.

19. A printing system, the system comprising:
one or more client devices configured to:
send an invitation email to a plurality of users, the invitation email being an invitation to a conference and/or a meeting;
receive a result of the invitation to attend the conference and/or the meeting from one or more users of the plurality of users via a response to the invitation email;
transfer an identifier to an image forming apparatus via a print email for each of the one or more users having accepted the invitation to attend the conference and/or the meeting;
transfer a material to be printed to the image forming apparatus via the print email for each of the one more user having accepted the invitation to attend the conference and/or the meeting; and
the image forming apparatus configured to:
print the material from the print email on the image forming apparatus based on a print preference setting for each of the one or more users having accepted the invitation to attend the conference and/or the meeting when the image forming apparatus has the print preference setting for a user; and
print the material from the print email on the image forming apparatus based on an original print setting of the material for each of the one or more users having accepted the invitation to attend the conference and/or the meeting when the image forming apparatus does not have the print preference setting for the user.

20. The system according to claim 19, wherein the one or more client devices are configured to:
store a listing of at least one of the one or more users on the image forming apparatus, the listing of the at least one of the one or more users of the plurality of users including the identifier for each of the at least one of the one or more users and the print preference setting for each of the at least one of the one or more users.

21. The non-transitory computer readable medium according to claim 15, further comprising:
assigning each of the one or more users a regular print preference setting, and wherein the regular print preference setting is a same print setting as the original print setting of the material or a different print setting as the original print setting of the material.

22. The non-transitory computer readable medium according to claim 15, further comprising:
hosting the identifier for the one or more users on the image forming apparatus.

23. The non-transitory computer readable medium according to claim 15, further comprising:
sending the print email for the one or more users having accepted the invitation to attend the conference and/or the meeting to a server;
hosting the identifier of the one or more users on the server;
retrieving the identifier of the one or more users from the server; and
sending the material to the image forming apparatus from the server with the identifier of the one or more users based on the print email received on the server.

24. The non-transitory computer readable medium according to claim 15, comprising:
providing the one or more users with a graphical user interface with a preference registration screen, the preference registration screen requesting print settings from a user, the print settings including document orientation, paper size, paper type, font style, font size, print or e-print, duplex printing, finishing, and/or N-in-1.
